(19) United States
(12) Patent Application Publication
(10) Pub. No.: US 2010/0219684 A1
(43) Pub. Date: Sep. 2, 2010

(54) POWER SUPPLY APPARATUS

(75) Inventor: Yasuhiro Iino, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/712,698

(22) Filed: Feb. 25, 2010

(30) Foreign Application Priority Data
Feb. 27, 2009 (JP) 2009-046976

(51) Int. Cl. H02J 9/00

(52) U.S. Cl. 307/23

(57) ABSTRACT

A power supply apparatus includes a first voltage raising unit raising an input voltage supplied from a power supply up to a first voltage, a first voltage reducing unit reducing the first voltage to an output voltage to be supplied to a first load circuit, a second voltage raising unit raising the input voltage supplied from the power supply to the first voltage, a capacitor connected to an output of the second voltage raising unit, and power passing unit [for bringing the power storage element] connecting an input of the first voltage reducing unit and the capacitor when a voltage across terminals of the capacitor exceeds an output voltage of the first voltage raising unit.

### CROSS-REFERENCE TO RELATED APPLICATIONS

This application is based upon and claims the benefit of priority of the prior Japanese Patent Application No. 2009-46976, filed on Feb. 27, 2009, the entire contents of which are incorporated herein by reference.

### FIELD

The embodiments discussed herein are related to a power supply apparatus.

### BACKGROUND

It has been difficult to determine what causes an unexpected disruption of power to a system such as a computer system. For example, the cause may be a utility power failure due to a natural hazard such as a thunderbolt, an instantaneous power interruption, a failure in an internal component of a power supply apparatus or a problem in a computer system.

Therefore, a typical power supply apparatus which supplies voltages from a single power supply to multiple (for example two) systems includes a capacitor in order to supply a voltage to one of the systems that is used for recording the status of the power supply apparatus in a communication log, and also to avoid an unexpected power feed interruption.

For example, as illustrated in FIG. 7, a feed circuit of a conventional power supply apparatus uses a boost converter (PS1) to increase an input voltage Vi of 27 volts (V) to a voltage V₀₁ of 50 V and a buck converter (PS2) to reduce the input voltage Vi to a voltage V₀₂ of 5 V for communication logging and outputs the voltages V₀₁ and V₀₂. The feed circuit includes a capacitor (C1) for maintaining a voltage for backing up the communication logging voltage. Without the capacitor in the feed circuit, if the input voltage is interrupted due to a utility power failure, for example, the supply of power to both converters (PS1 and PS2) are interrupted at the same time and accordingly V₀₁ and V₀₂ would drop to zero as illustrated in FIG. 8. The capacitor provided in the feed circuit can supply a voltage to allow a utility power failure, for example, to be recorded in the log even though the input voltage is interrupted due to the utility power failure as illustrated in FIG. 9. The amount of time during which the voltage is maintained increases with the capacity of the capacitor, and accordingly the occurrence of the utility power failure can be more reliably recorded in the log.

A feed circuit technique has been disclosed in which a voltage doubler rectifier is used to approximately double the voltage value of an input voltage so that more energy than would be held with the original input voltage value is stored in the capacitor. If the input voltage is interrupted due to a utility power failure, for example, the energy stored in the capacitor is converted to a predetermined output voltage to extend the period of time during which the output voltage is maintained. In this feed circuit, a transistor that is equivalent to a variable resistance is used for a voltage stabilizer circuit (dropper method). When a high voltage is applied to the transistor, a power loss occurs. To prevent an excessively high voltage from being applied to the transistor, a switch circuit that controls energy output from the capacitor is added.

### SUMMARY

According to an embodiment, a power supply apparatus includes a first voltage raising unit raising an input voltage supplied from a power supply up to a first voltage, a first voltage reducing unit reducing the first voltage to an output voltage to be supplied to a first load circuit, a second voltage raising unit raising the input voltage supplied from the power supply to the first voltage, a capacitor connected to an output of the second voltage raising unit, and power passing unit connecting an input of the first voltage reducing unit and the capacitor when a voltage across terminals of the capacitor exceeds an output voltage of the first voltage raising unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating a configuration of a power supply apparatus according to a first embodiment;

FIG. 2 is a block diagram illustrating a configuration of a non-isolation feed circuit according to the first embodiment;

FIG. 3 is a timing chart illustrating the relationship between various voltages applied to a capacitor and output voltages of the power supply apparatus;

FIG. 4 is a flowchart illustrating operation of the non-isolation feed circuit according to the first embodiment;

FIG. 5 is a block diagram illustrating a configuration of an isolation feed circuit according to a second embodiment;

FIG. 6 is a flowchart illustrating operation of the isolation feed circuit according to the second embodiment;

FIG. 7 is an illustration of a feed circuit using a conventional power feeding method;

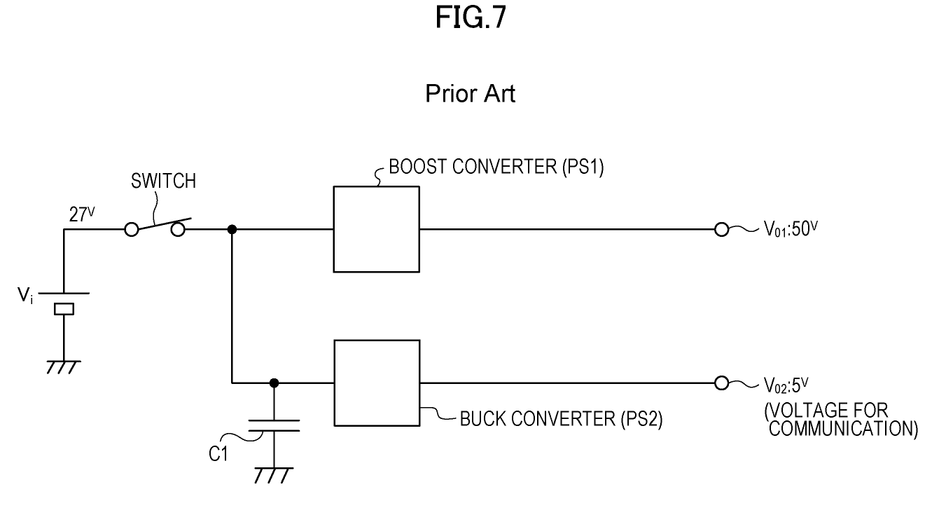

FIG. 8 is a timing chart of the conventional feed circuit; and

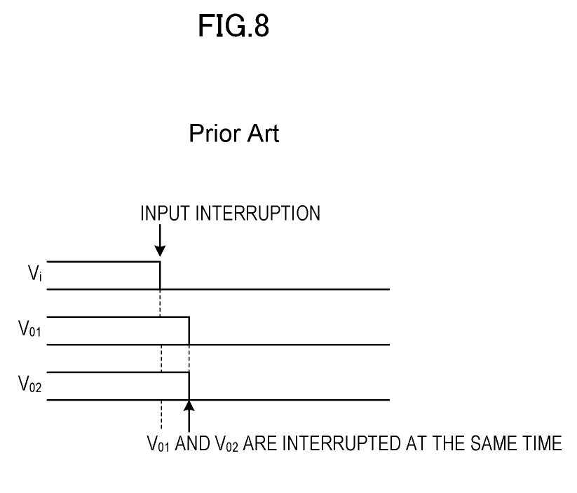

FIG. 9 is a timing chart of the conventional feed circuit.

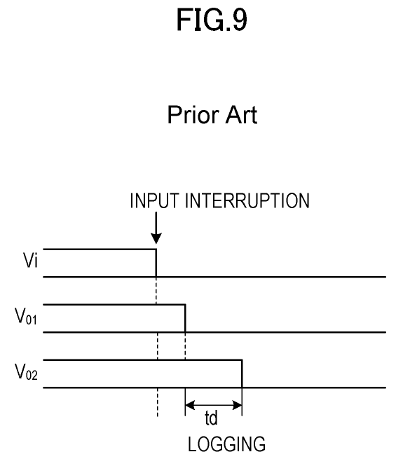

### DESCRIPTION OF EMBODIMENTS

The conventional power supply apparatus that can maintain an output voltage for an extended period of time in the event of an input voltage interruption due to a utility power failure for example, has the problem that the size of the power supply apparatus itself is inevitably large.

In the power supply apparatus including the capacitor for maintaining an output voltage, the capacity of the capacitor needs to be large in order to maintain the output voltage for a sufficient period of time, which increases the size of the power supply apparatus.

On the other hand, in the conventional feed circuit that doubles the input voltage value to store energy in the capacitor, the capacity of the capacitor can be reduced to ¼ of that of the capacitor in the above-described power supply apparatus because the energy stored in the capacitor is proportional to the square of the voltage. However, the dropper method used in the feed circuit requires an additional circuit such as a voltage selector switch circuit in order to prevent waste of the energy stored in the capacitor.

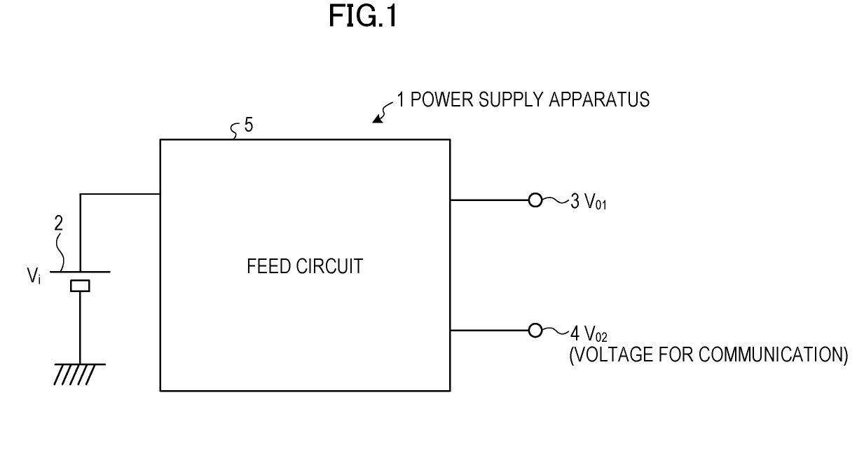

FIG. 1 is a block diagram schematically illustrating a configuration of a power supply apparatus according to a first embodiment. As illustrated in FIG. 1, the power supply apparatus 1 includes a DC power supply 2 which supplies power to two load circuits, and a feed circuit 5 which supplies predetermined output voltages from the power supply 2 to the two load circuits. While the power supply apparatus 1 in the example illustrated in FIG. 1 supplies power from the power supply 2 to the two load circuits, the power supply apparatus 1 is not limited to this. The power supply apparatus 1 may supply power from the power supply 2 to more than two load circuits.

Predetermined output voltage V₀₁ 3 is supplied from the feed circuit 5 to one of the load circuits, which is a circuit of a heating appliance or an electronic computer, for example, that requires a voltage higher than the input voltage supplied from the power supply 2.

Predetermined output voltage V₀₂ (voltage for communication) 4 is supplied from the feed circuit 5 to the other load circuit than one supplied with V₀₁ 3. The load circuit supplied with V₀₂ (voltage for communication) 4 is a circuit of a communication log device, for example, used for recording the status of the power supply apparatus 1 in the log at regular intervals. The voltage V₀₂ 4 may be lower than the voltage V₀₁ 3 and lower than the input voltage Vi supplied from the power supply 2.

Unless the input voltage Vi from the power supply 2 is interrupted, the feed circuit 5 increases the input voltage Vi supplied from the power supply 2 to a voltage higher than the input voltage Vi and applies the increased voltage to a capacitor (not shown) to store charge in the capacitor while decreasing the voltage to the level of the output voltage V₀₂ (voltage for communication) 4 and supplies the decreased voltage V₀₂ (voltage for communication) 4 to the load circuit. In the event of an interruption of the input voltage Vi from the power supply 2 due to a utility power failure, for example, the feed circuit 5 uses the same path to decrease the voltage equivalent to the charge stored in the capacitor to the level of the output voltage V₀₂ (voltage for communication) 4 and supply the output voltage V₀₂ (voltage for communication) 4 to the load circuit. The higher the voltage applied to the capacitor, the longer the feed circuit 5 can maintain the output voltage V₀₂ (voltage for communication) 4 in the event of an interruption of the input voltage Vi from the power supply 2, because the energy stored in the capacitor increases with increasing voltage applied to the capacitor.

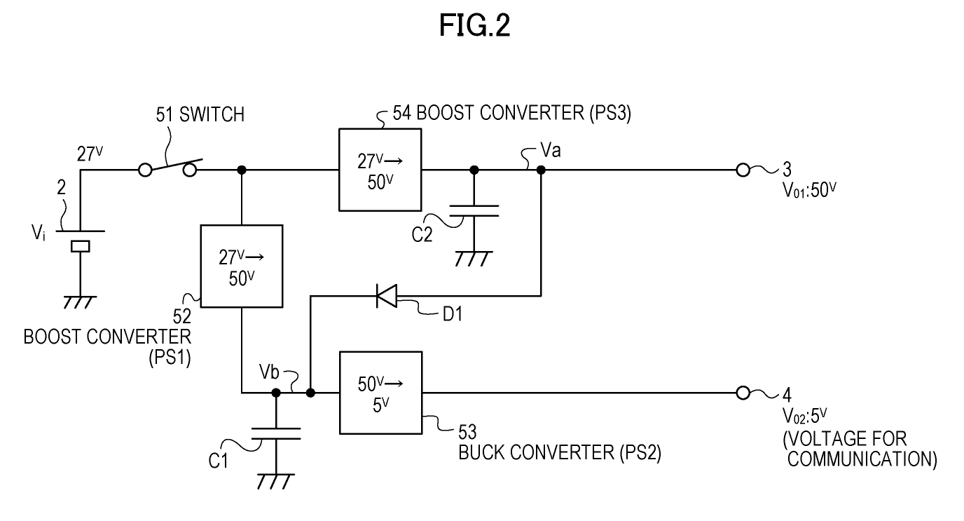

FIG. 2 is a block diagram illustrating a non-isolation feed circuit according to the first embodiment. As illustrated in FIG. 2, the feed circuit 5 includes a switch 51, a boost converter (PS1) 52, a buck converter (PS2) 53, a boost converter (PS3) 54, capacitors C1 and C2, and a diode D1.

The switch 51 is a switch element that connects (ON) and disconnects (OFF) the power supply 2 to and from the boost converters (PS1 and PS3) 52 and 54. When the input voltage Vi is supplied form the power supply 2, the switch 51 turns on and supplies the input voltage Vi from the power supply 2 to the boost converters (PS1 and PS3) 52 and 54. When the input voltage Vi from the power supply 2 is interrupted due to a utility power failure, for example, the switch 51 turns off and blocks the supply of the input voltage Vi to the boost converters (PS1 and PS3) 52 and 54. In the example in FIG. 2, the input voltage Vi from the power supply 2 is 27 V.

When the boost converter (PS1) 52 is supplied with the input voltage Vi from the power supply 2 through the switch 51, the boost converter (PS1) 52 increases the input voltage Vi to a predetermined voltage (50 V in the example in FIG. 2) that is higher than the input voltage Vi and supplies the increased voltage to the capacitor C1 and the buck converter (PS2) 53. While the boost converter (PS1) 52 increases the input voltage Vi (27 V) to 50 V in the example in FIG. 2, the boost converter (PS1) 52 may convert the input voltage Vi (27 V) up to any voltage that is higher than the output voltage V₀₁ 3.

The capacitor C1 is provided between and connected to the boost converter (PS1) 52 and the buck converter (PS2) 53. A voltage supplied from the boost converter (PS1) 52 is applied to the capacitor C1, which stores charge equivalent to the applied voltage while at the same time supplying a voltage equivalent to the stored charge to the buck converter (PS2) 53. When the input voltage Vi from the power supply 2 is interrupted, the application of voltage from the boost converter (PS1) 52 to the capacitor C1 ceases and the capacitor C1 supplies the voltage equivalent to the charge that has been stored in the capacitor C1 to the buck converter (PS2) 53. Since the capacitor C1 has been charged with a voltage (50 V) higher than the input voltage Vi (27 V) while the input voltage Vi was being supplied from the power supply 2, the capacitor C1 has stored charge with a higher energy than the energy that would be stored if the capacitor C1 was charged with the input voltage Vi (27 V). Accordingly, if the input voltage Vi from the power supply 2 is interrupted, the output voltage V₀₂ (voltage for communication) 4 can be maintained for an extended period of time. In the case of an interruption of the input voltage Vi from the power supply 2, the voltage in the capacitor C1 decreases as the charge stored in the capacitor C1 is output. Therefore, a voltage supplied from the other capacitor C2, which will be described later, is further applied to the capacitor C1 to store charge equivalent to the applied voltage. A voltage equivalent to the stored charge is supplied to the buck converter (PS2) 53. Thus the capacitor C1 can maintain the output voltage V₀₂ (voltage for communication) 4 for a longer period of time.

The buck converter (PS2) 53 is a switching regulator that decreases an input voltage by switching operation to produce an output voltage. The buck converter (PS2) 53 uses a switching ratio (for example a duty cycle) corresponding to an available input voltage to convert the input voltage down to a predetermined voltage. Specifically, when the input voltage Vi from the power supply 2 is not interrupted, the buck converter (PS2) 53 is supplied with a voltage from the boost converter (PS1) 52, reduces the supplied voltage to an output voltage V₀₂ (voltage for communication) 4 of 5 V, for example, and supplies the reduced voltage to the load circuit. When the input voltage Vi from the power supply 2 is interrupted, the boost converter (PS1) 52 ceases applying the voltage and the buck converter (PS2) 53 is supplied with voltage from the capacitors C1, C2, reduces the supplied voltage to an output voltage V₀₂ (voltage for communication) 4 of 5 V, for example, and supplies the reduced voltage to the load circuit. In the example in FIG. 2, the available input voltages range from 50 V to 5 V. The voltage supplied from the capacitors C1, C2 varies in a wide range from a high voltage (50 V) to a low voltage (5 V). The buck converter (PS2) 53 is capable of efficiently converting any voltage in the range to an output voltage because the buck converter (PS2) 53 is a switching regulator.

When the boost converter (PS3) 54 is supplied with the input voltage Vi from the power supply 2 through the switch 51, the boost converter (PS3) 54 increases the input voltage Vi to a predetermined voltage (an output voltage V₀₁ 3 of 50 V in the example in FIG. 2) higher than the input voltage Vi, and supplies the increased voltage to the capacitor C2 as well as the load circuit.

The capacitor C2 is provided between and connected to the boost converter (PS3) 54 and the diode D1. A voltage supplied from the boost converter (PS3) 54 is applied to the capacitor C2. The capacitor C2 stores charge equivalent to the applied voltage and supplies an output voltage V₀₁ 3 equivalent to the stored charge to the load circuit. If the input voltage Vi from the power supply 2 is interrupted, the application of voltage from the boost converter (PS3) 54 to the capacitor C2 ceases and therefore the capacitor C2 supplies a voltage equivalent to the charge that has been stored in the capacitor C2 to the diode D1 and the load circuit.

The diode D1 is a directional element that transfers charges from a path (C2-path) through which charges travel to the load circuit that is supplied with the output voltage V₀₁ 3 from the capacitor C2 to a path (C1-path) through which charges travel from the capacitor C1 to the buck converter (PS2) 53. The diode D1 transfers charges on the basis of the voltages on its ends connected to the paths. This is done in order to recharge the capacitor C1 when the input voltage Vi from the power supply 2 is interrupted. Specifically, in the event of an interruption of the input voltage Vi from the power supply 2, the diode D1 transfers a charge corresponding to the voltage on the C2-path side to the C1-path side when the voltage Va on the C2-path side exceeds the voltage Vb on the C-1 path side. That is, as charges stored in the capacitor C1 are output, the voltage Vb decreases and, when the voltage Vb falls below the voltage Va, the diode D1 allows charges stored in the capacitor C2 to travel to the capacitor C1. As a result, the capacitor C1 can further store the charges traveled to the capacitor C1 and therefore can maintain the output voltage V₀₂ (voltage for communication) 4 for an extended period of time.

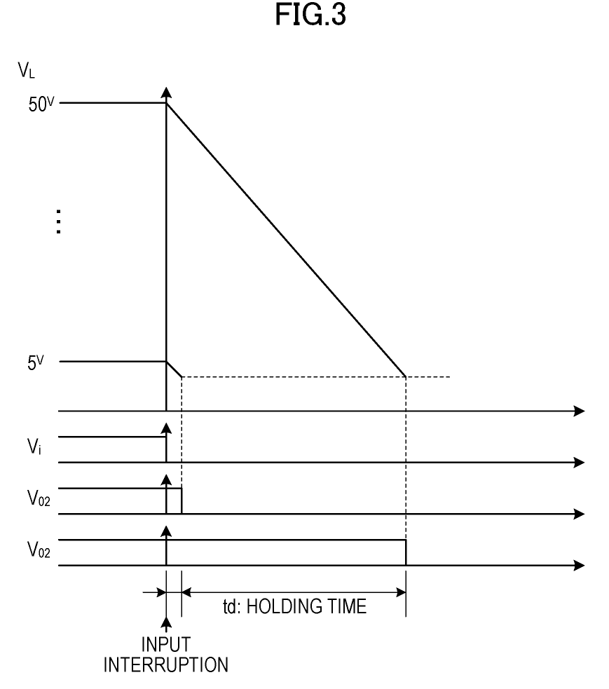

FIG. 3 is a timing chart illustrating the relationship between various voltages (V_{L}) applied to the capacitor and output voltage of the power supply apparatus 1. An example in which voltages of 5 V and 50 V are applied to capacitor C1 with the same capacity will be described with respect to FIG. 3.

The time for which the output voltage V₀₂ (voltage for communication) 4 is maintained by energy stored in the capacitor C1 when the input voltage Vi is interrupted varies with voltage, 5 V or 50 V, applied to the capacitor C1 in the presence of the input voltage Vi. In general, the energy stored in the capacitor C1 is proportional to the square of the voltage applied to the capacitor C1. Therefore, the energy stored in the capacitor C1 to which a voltage of 50 V has been applied is approximately 100 times greater than the energy stored in the capacitor C1 to which a voltage of 5 V has been applied.

Accordingly, the higher the voltage applied to the capacitor C1, the longer the capacitor 1 can supply the output voltage V₀₂ (voltage for communication) 4 to the load circuit when the input voltage Vi is interrupted. In the example in FIG. 3, the time for which the output voltage V₀₂ is maintained in the capacitor C1 charged with 50 V is longer by td than the time for which the output voltage V₀₂ is maintained in the capacitor C1 charged with 5 V. This ensures that the cause of an input voltage Vi interruption (for example a utility power failure) is reliably recorded in the log in the load circuit supplied with the output voltage V₀₂ (voltage for communication) 4.

If the capacity of the capacitor C1 is reduced, a comparable energy can be ensured by increasing the voltage because the energy stored in the capacitor C1 in general is proportional to the square of the voltage as well as to the capacity of the capacitor C1. When the input voltage Vi is interrupted, it takes approximately 20 milliseconds for example, to record the interruption in the log. Therefore, the capacity of the capacitor C1 storing energy that can maintain the output voltage V₀₂ (voltage for communication) 4 for that length of time can be decreased with increasing voltage applied to the capacitor C1.

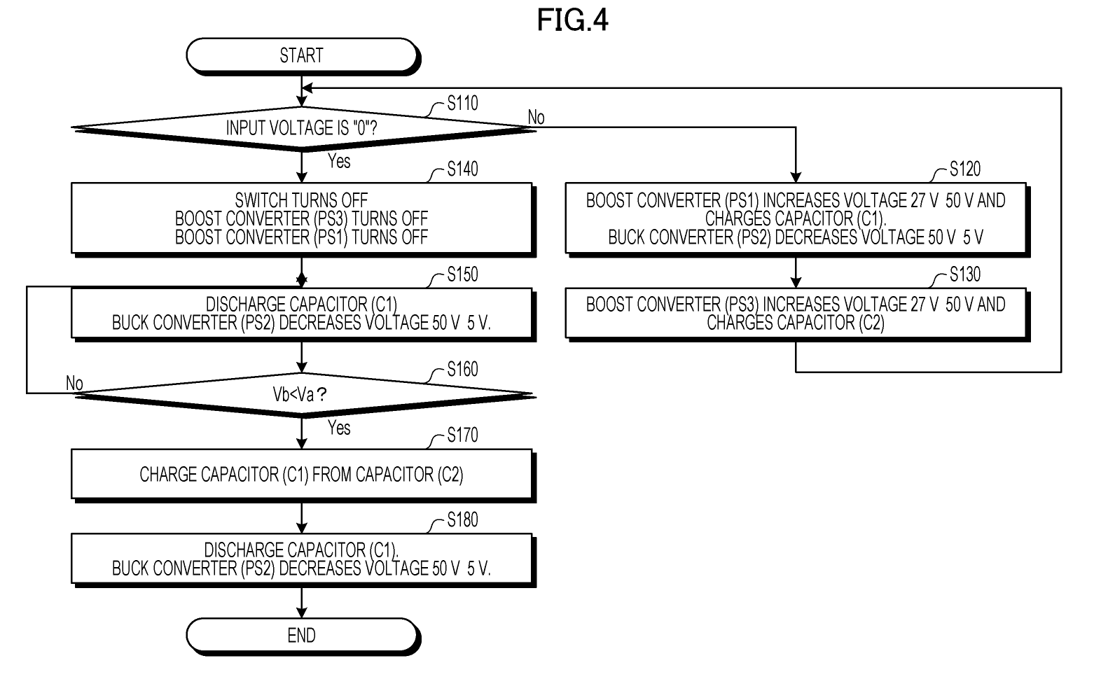

Operation of the non-isolation feed circuit according to the first embodiment will be described next with reference to FIG. 4. FIG. 4 is a flowchart illustrating a process performed in the non-isolation feed circuit according to the first embodiment.

Unless an input voltage Vi of 27 V, for example, from the power supply 2 is interrupted, the switch 51 turns on by the supply of the input voltage Vi from the power supply 2 and supplies the input voltage Vi to the boost converters (PS1 and PS3) 52 and 54.

The switch 51 determines whether the input voltage Vi is “0” or not (S110). If the switch 51 determines that the input voltage Vi is not “0” (No at S110), the switch 51 supplies the input voltage Vi to the boost converters (PS1 and PS3) 52 and 54.

The boost converter (PS1) 52, supplied with the input voltage Vi, increases the input voltage Vi of 27 V to 50 V. The increased voltage charges the capacitor C1 and is reduced to an output voltage V₀₂ (voltage for communication) 4 of 5 V, for example, by the buck converter (PS2) 53, then supplied to the load circuit (S120).

The boost converter (PS3) 54, supplied with the input voltage Vi, increases the input voltage Vi of 27 V to 50 V, for example. The increased voltage charges the capacitor C2 and is supplied to the load circuit as an output voltage V₀₁ 3 (S130).

On the other hand, if the switch 51 determines that the input voltage V1 is “0” (Yes at 5110), the switch 51 turns off and therefore the input voltage Vi cannot be supplied. Consequently, the boost converters (PS1 and PS3) 52 and 54 halt (S140).

Since the supply of the input voltage Vi from the boost converter (PS1) 52 has ceased, the voltage equivalent to the charge stored in the capacitor C1 is reduced to an output voltage V₀₂ (voltage for communication) 4 of 5 V by the buck converter (PS2) 53 and is then supplied to the load circuit (S150).

The diode D1 determines whether the voltage Va on the capacitor C2 side is higher than the voltage Vb on the capacitor C1 side (S160). If the voltage Va on the capacitor C2 side is lower than or equal to the voltage Vb on the capacitor C1 side (No at S160), the diode D1 does not transfer the charges stored in the capacitor C2 to the capacitor C1 and the capacitor C1 continues to discharge the charges stored.

On the other hand, if the voltage Va on the capacitor C2 side is higher than the voltage Vb on the capacitor C1 side (Yes at S160), the diode D1 transfers charges stored in the capacitor C2 to the capacitor C1 to recharge the capacitor C1 (S170).

The voltage equivalent to the charge stored in the capacitor C1 is reduced to an output voltage V₀₂ (voltage for communication) 4 of 5 V by the buck converter (PS2) 53 and is then supplied to the load circuit (S180).

As has been described above, in the power supply apparatus 1 according to the first embodiment, the boost converter (PS1) 52 increases the input voltage Vi supplied from the power supply 2 to a higher voltage than the input voltage Vi. Then, the buck converter (PS2) 53 in the power supply apparatus 1 decreases the voltage increased by the boost converter (PS1) 52 to an output voltage to be applied to the load circuit. The voltage increased by the boost converter (PS1) 52 is applied to the capacitor C1 provided between the boost converter (PS1) 52 and the buck converter (PS2) 53 in the power supply apparatus 1 to store charges in the capacitor C1. If the input voltage Vi decreases to “0”, the buck converter (PS2) 53 in the power supply apparatus 1 reduces the voltage equivalent to the charge stored in the capacitor C1 to an output voltage to be applied to the load circuit.

In this way, the provision of the capacitor C1 in the path in the power supply apparatus 1 through which a voltage is supplied to the load circuit when the input voltage Vi is supplied from the power supply 2 eliminates the need for providing a dedicated component as a measure against an interruption of the input voltage Vi. Consequently, the power supply apparatus can be reduced in size and cost.

Furthermore, since the power supply apparatus 1 increases the input voltage Vi and applies the increased voltage to the capacitor C1, more energy can be stored in the capacitor C1 than the case where the input voltage Vi is directly applied to the capacitor C1. Accordingly, the output voltage being applied to the load circuit can be maintained longer. Consequently, if the load circuit is a circuit for logging, the load circuit can reliably record the cause of an interruption of the input voltage Vi (for example a utility power failure) in the log.

In addition, since the power supply apparatus 1 increases the input voltage Vi and applies the increased voltage to the capacitor C1, the capacity of the capacitor C1 can be reduced compared with the case where the input voltage Vi is directly applied to the capacitor C1 and therefore the size of the entire power supply apparatus 1 can be reduced.

While the first embodiment has been described with respect to a non-isolation feed circuit by way of example, the feed circuit may be an isolation feed circuit. A power supply apparatus including an isolation feed circuit will be described as a second embodiment.

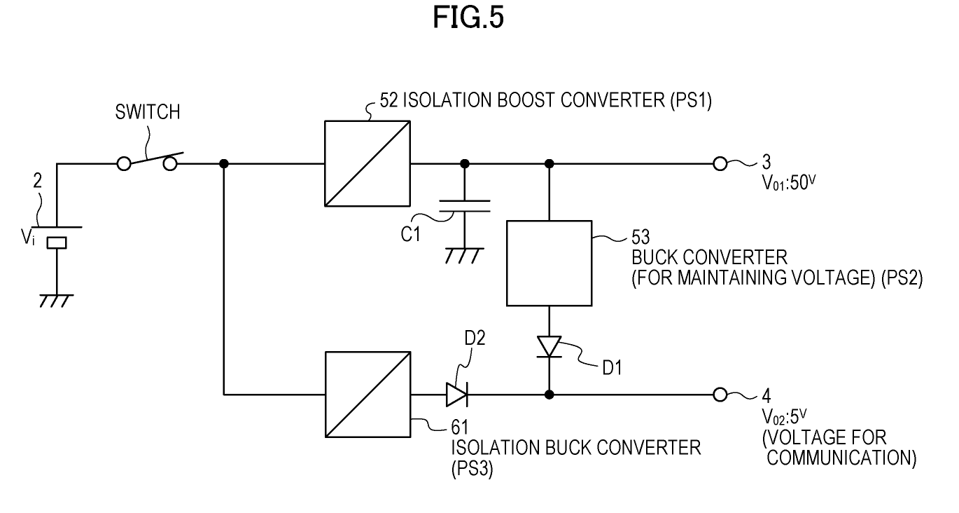

FIG. 5 is a block diagram illustrating a configuration of an isolation feed circuit according to the second embodiment. As illustrated in FIG. 5, the feed circuit according to the second embodiment differs from the feed circuit according to the first embodiment (FIG. 2) in that the boost converter (PS3) 54 and the capacitor C2 are omitted, an isolation buck converter (PS3) 61 and a diode D2 are added, and the boost converter (PS1) 52 is replaced with an isolation boost converter (PS1) 52. In FIG. 5, the same components as those in FIG. 2 are labeled the same reference symbols and detailed description of those components will be omitted.

The isolation buck converter (PS3) 61 is a switching regulator that includes an isolation transformer and reduces an input voltage Vi passing through the isolation transformer by switching operation to produce an output voltage. The isolation buck converter (PS3) 61 uses a switching ratio (for example a duty cycle) corresponding to an available input voltage to reduce the input voltage Vi to a predetermined voltage. Specifically, if the input voltage Vi from a power supply 2 is not interrupted, the isolation buck converter (PS3) 61 is supplied with the input voltage Vi from the power supply 2 through a switch 51, reduces the supplied voltage to an output voltage V₀₂ (voltage for communication) 4 of 5 V, for example, and supplies the output voltage V₀₂ (voltage for communication) 4 to a load circuit through the diode D2.

The isolation buck converter (P51) 52 includes an isolation transformer and increases the input voltage Vi passing through the isolation transformer to a predetermined voltage (an output voltage V₀₁ 3 of 50 V in the example in FIG. 5) higher than the input voltage Vi. The isolation boost converter (PS1) 52 supplies the increased voltage to the capacitor C1 as well as a load circuit.

A buck converter (for maintaining voltage) (PS2) 53 is a switching regulator that reduces an input voltage by switching operation to produce an output voltage. The buck converter (PS2) 53 uses a switching ratio (for example a duty cycle) corresponding to an available input voltage to reduce the input voltage to a predetermined voltage. Specifically, if the input voltage Vi from the power supply 2 is not interrupted, the buck converter (for maintaining voltage) (PS2) 53 is supplied with the voltage (50 V) supplied from the isolation boost converter (P51) 52 and reduces the supplied voltage to an output voltage V₀₂ (voltage for communication) 4 of 5 V, for example. While the buck converter (for maintaining voltage) (PS2) 53 reduces the voltage to an output voltage V₀₂ (voltage for communication) 4 of 5 V, the buck converter (PS2) 53 may reduce the voltage to a voltage lower than 5 V.

The diode D1 is a directional element which transfers charges from the path (V₀₁ path) through which charges travel from the capacitor C1 to the load circuit supplied with V₀₁ 3 to the path (V₀₂ path) through which charges travel from the isolation buck converter (PS3) 61 to the load circuit supplied with V₀₂ 4 (voltage for communication).

The diode D2 is a directional element which transfers charges from the isolation buck converter (PS3) 61 to the load circuit supplied with V₀₂ 4 (voltage for communication).

The diodes D1 and D2 constitute an OR circuit. Specifically, one of the input voltages input into the diodes D1 and D2 is supplied to the load circuit to be supplied with V₀₂ 4 (voltage for communication). If the input voltage Vi from the power supply 2 is interrupted and the input voltage applied to the diode D2 becomes zero, the voltage supplied from the capacitor C1 is decreased by the buck converter (for maintaining voltage) (PS2) 53 and the decreased voltage is supplied to the V₀₂ (voltage for communication) 4 through the diode D1. Since the capacitor C1 has been charged with a voltage (50 V) higher than the input voltage Vi (27 V) while the power supply 2 has been supplying the input voltage Vi, the capacitor C1 has stored charge with more energy than the case where the capacitor C1 is charged with the input voltage Vi (27 V). Accordingly, if the input voltage Vi from the power supply 2 is interrupted, the capacitor C1 can maintain the output voltage V₀₂ (voltage for communication) 4 for a longer period of time.

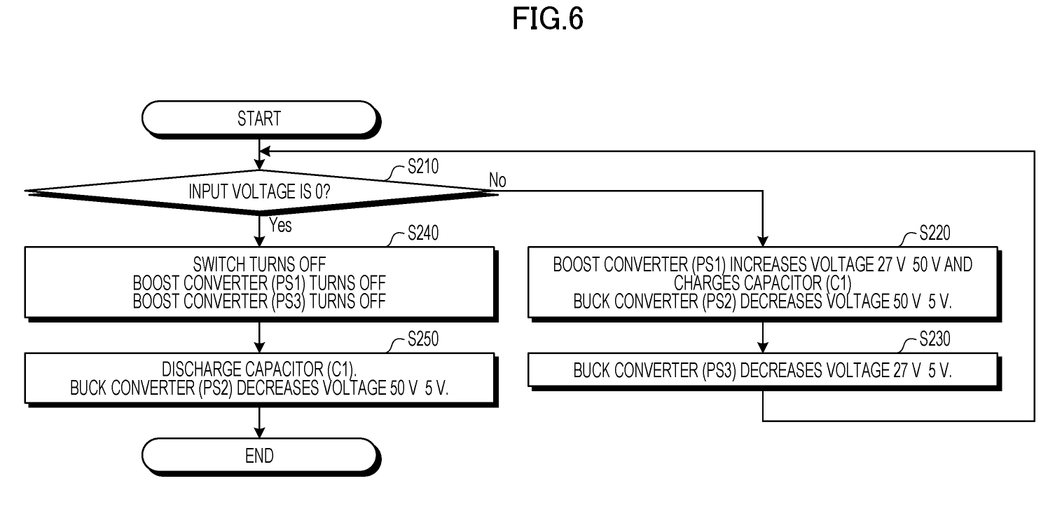

Operation of the isolation feed circuit according to the second embodiment will be described below with reference to FIG. 6. FIG. 6 is a flowchart illustrating a process performed in the isolation feed circuit according to the second embodiment.

If the input voltage Vi (for example 27V) from the power supply 2 is not interrupted, the switch 51 turns on by the supply of input voltage Vi from the power supply 2 and supplies the input voltage Vi to the isolation boost converter (PS1) 52 as well as the isolation buck converter (PS3) 61.

The switch 51 determines whether the input voltage Vi is “0” or not (S210). If the switch 51 determines that the input voltage Vi is not “0” (No at S210), the switch 51 supplies the input voltage Vi to the isolation boost converter (PS1) 52 and the isolation buck converter (PS3) 61.

The isolation boost converter (PS1) 52, supplied with the input voltage Vi, increases the input voltage Vi to 50 V. The increased voltage charges the capacitor C1 and is also supplied to the load circuit as the output voltage V₀₁ 3. The buck converter (for maintaining voltage) (PS2) 53 decreases the voltage increased by the isolation boost converter (PS1) 52 to an output voltage V₀₂ (voltage for communication) 4 of 5 V, for example (S220).

The isolation buck converter (PS3) 61, supplied with the input voltage Vi, decreases the input voltage Vi to an output voltage V₀₂ (voltage for communication) 4 of 5 V (S230). Then the OR circuit composed of the diodes D1 and D2 provides one of the output voltage decreased by the isolation buck converter (PS3) 61 and the output voltage decreased by the buck converter (for maintaining voltage) (PS2) 53 to the load circuit as the output voltage V₀₂ (voltage for communication) 4.

On the other hand, if the switch 51 determines that the input voltage V1 is “0” (Yes at S210), the switch 51 turns off. Consequently, since the input voltage Vi cannot be supplied to the isolation boost converter (PS1) 52 and the isolation buck converter (PS3) 61, the isolation boost converter (PS1) 52 and the isolation buck converter (PS3) 61 halt (S240).

Since the supply of voltage from the isolation buck converter (PS3) 61 has cease, the voltage equivalent to the charge stored in the capacitor C1 is decreased to an output voltage V₀₂ (voltage for communication) 4 of 5 V by the buck converter (PS2) 53 and is then supplied to the load circuit through the diode D1 (S250).

As has been described above, in the power supply apparatus 1 according to the second embodiment, the isolation boost converter (P51) 52 increases the input voltage Vi supplied from the power supply 2 to a higher voltage than the input voltage Vi. Then, the buck converter (PS2) 53 in the power supply apparatus 1 decreases the voltage increased by the isolation boost converter (PS1) 52 to an output voltage to be applied to the load circuit. The voltage increased by the isolation boost converter (PS1) 52 is applied to the capacitor C1 provided between the isolation boost converter (PS1) 52 and the buck converter (PS2) 53 in the power supply apparatus 1 to store charges in the capacitor C1. If the input voltage Vi decreases to “0”, the buck capacitor (PS2) 53 in the power supply apparatus 1 reduces the voltage equivalent to the charge stored in the capacitor C1 to an output voltage to be applied to the load circuits. The isolation buck converter (PS3) 61 in the power supply apparatus 1 converts the input voltage Vi supplied from the power supply 2 to an output voltage to be applied to the load circuit. Then, charge corresponding to one of the output voltage supplied as a result of the conversion by the buck converter (PS2) 53 and the output voltage supplied as a result of the conversion by the isolation buck converter (PS3) 61 is transferred to the load circuit through the diodes D1 and D2 by the power supply apparatus 1.

In this way, the provision of the capacitor C1 in the path in the power supply apparatus 1 through which a voltage is supplied to the load circuit when the input voltage Vi is supplied from the power supply 2 eliminates the need for providing a dedicated component as a measure against an interruption of the input voltage Vi. Consequently, the power supply apparatus can be reduced in size and cost.

Furthermore, since the power supply apparatus 1 increases the input voltage Vi and applies the increased voltage to the capacitor C1, more energy can be stored in the capacitor C1 than the case where the input voltage Vi is directly applied to the capacitor C1. Accordingly, the output voltage being applied to the load circuit can be maintained longer. Consequently, if the load circuit is a circuit for logging, the load circuit can reliably record the cause of an interruption of the input voltage Vi (for example a utility power failure) in the log.

In addition, since the power supply apparatus 1 increases the input voltage Vi and applies the increased voltage to the capacitor C1, the capacity of the capacitor C1 can be reduced compared with the case where the input voltage V1 is directly applied to the capacitor C1 and therefore the size of the entire power supply apparatus 1 can be reduced.

Moreover, since the input and output of each of the isolation boost converter (PS1) 52 and the isolation buck converter (PS3) 61 in the power supply apparatus 1 which supply the input voltage Vi from the power supply 2 are isolated from each other, the power supply apparatus 1 can be protected against the impact of a lightning surge or other hazard.

The processing functions of the components of the power supply apparatus 1 may be implemented by a CPU (Central Processing Unit) (or a microcomputer such as an MPU (Micro Processing Unit) or MCU (Micro Controller Unit)) and a program which is analyzed and executed by the CPU (or the micro computer such as MPU or MCU), or may be implemented as wired-logic hardware.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A power supply apparatus comprising:
a first voltage raising unit raising an input voltage supplied from a power supply up to a first voltage;
a first voltage reducing unit reducing the first voltage to an output voltage to be supplied to a first load circuit;
a second voltage raising unit raising the input voltage supplied from the power supply to the first voltage;
a capacitor connected to an output of the second voltage raising unit; and
a power passing unit connecting an input of the first voltage reducing unit and the capacitor when a voltage across terminals of the capacitor exceeds an output voltage of the first voltage raising unit.

2. The power supply apparatus according to claim 1, wherein the power passing unit is a switching element.

3. The power supply apparatus according to claim 1, wherein the power passing unit is a diode.

4. A power supply apparatus comprising:
a first voltage reducing unit reducing an input voltage supplied from a power supply to a first voltage;
a first voltage raising unit raising the input voltage up to a second voltage;
a capacitor connected to an output of the first voltage raising unit;
a second voltage reducing unit connected to an output of the first voltage raising unit; and
a power passing unit connecting an output of the first voltage reducing unit and an output of the second voltage reducing unit when an output voltage of the first voltage reducing unit drops an output voltage of the second voltage reducing unit.
